(19) United States
(12) Patent Application Publication
(10) Pub. No.: US 2018/0103372 A1
(43) Pub. Date: Apr. 12, 2018

(54) SYSTEM AND METHOD FOR CONNECTING A Wi-Fi PRODUCT TO A Wi-Fi NETWORK

(71) Applicant: Wai-Pun Chung, Kwai Chung (HK)

(72) Inventor: Wai-Pun Chung, Kwai Chung (HK)

(21) Appl. No.: 15/287,865

(22) Filed: Oct. 7, 2016

(51) Int. Cl. H04W 12/06; H04W 4/00; H04W 76/02; H04L 29/06

(52) U.S. Cl. CPC H04W 12/06; H04W 4/008; H04L 12/2803; H04L 63/083; H04W 76/023

(57) ABSTRACT

Disclosed is a method and system for connecting a Wi-Fi product to an available Wi-Fi network using a Bluetooth connection. The method includes connecting, the Wi-Fi product to an electronic device through the Bluetooth connection, inputting, an authentication credentials related to the available Wi-Fi network over the electronic device by a user, where the input of the authentication credentials is facilitated by an application residing on a memory medium of the electronic device, sending, by the electronic device, the authentication credentials to Bluetooth module of the Wi-Fi product, sending, by the Bluetooth module, the authentication credentials to a Wi-Fi module configured in the at least one Wi-Fi product and communicatively linked with the Bluetooth module, and registering, the authentication credentials with the available Wi-Fi network for connecting the Wi-Fi module to the available Wi-Fi network.

### CROSS-REFERENCE TO RELATED APPLICATIONS

This application claims the benefit of U.S. provisional patent application Ser. No. 62/240,508, filed on Oct. 12, 2015, entitled “CONNECTING AN ELECTRONIC DEVICE TO A Wi-Fi NETWORK” the entire contents of which are incorporated herein by reference.

### FIELD OF THE DISCLOSURE

The present disclosure generally relates to field of communication, more specifically, the present disclosure relates to connecting a Wi-Fi product to a Wi-Fi network using a Bluetooth low energy communication.

### BACKGROUND

Bluetooth Low Energy (BLE) may be understood as a wireless technology that may be implemented in electronic devices, such as computers, smart phones, laptops, and smart home products. Bluetooth Low Energy(BLE) devices can be directly connected to smart phones or the like devices of the user without the hassle of doing pairing procedure, when the BLE devices are within the required proximity. For the purpose of BLE connectivity, the smart phones and the like devices include a preloaded application that can auto search for the available BLE devices within proximity and directly connect thereto.

With the advancement in the technologies, now a days, products for example computers and related accessories, gaming medias, tablets, cameras, TVs, various smart home products such as energy monitors, lighting gateways, doorbells, air conditioners, thermostat are all enabled to communicate wirelessly over internet using Wi-Fi connectivity. Such devices, can be collectively called Wi-Fi products. In order to use such Wi-Fi products, it is essential that such devices are initially connected to the conventional available Wi-Fi network obtained using Wi-Fi devices like Wi-Fi router.

We know, while connecting the Wi-Fi product to the Wi-Fi network, normally, the Wi-Fi product has to search for the available Wi-Fi network and then connect to the network. However, most of Wi-Fi products, especially smart home products such as energy monitors, lighting gateways, doorbells, air conditioners, and the thermostat do not seem to have an input medium, such as a touch screen or a keyboard, to search for the available Wi-Fi network and to enter an authentication code or an associated password to connect the Wi-Fi product to the Wi-Fi network. Thus, connecting the Wi-Fi product to the Wi-Fi network is difficult in such circumstances.

### SUMMARY

According to an aspect of the present invention, there is provided a system for connecting at least one Wi-Fi product to an available Wi-Fi network using a Bluetooth connection. The system includes at least electronic device comprising at least one processor, at least one memory medium, the at least one memory medium having stored thereon computer-executable code which, when executed by the at least one processor enables a user to input at least one authentication credentials related to the available Wi-Fi network over the at least one electronic device, at least one Bluetooth module configured in the at least one Wi-Fi product for establishing the bluetooth connection with the at least electronic device, wherein the Bluetooth connection enables the at least one Bluetooth module to receive the at least one authentication credentials inputted by the user on the at least one electronic device, and at least one Wi-Fi module configured in the at least one Wi-Fi product, wherein the at least one Wi-Fi module is communicatively linked with the at least one Bluetooth module to receive the at least one authentication credentials therefrom for registering and connecting the at least one Wi-Fi product with the available Wi-Fi network.

According to another aspect of the present invention, there is provided a method for connecting at least one Wi-Fi product to an available Wi-Fi network using a Bluetooth connection. The method includes connecting, the at least one Wi-Fi product to at least one electronic device through the Bluetooth connection, wherein the connection with the at least one electronic device is established by the at least one Wi-Fi product using at least one Bluetooth module configured therein, inputting, at least one authentication credentials related to the available Wi-Fi network over the at least one electronic device by a user, wherein the input of the at least one authentication credentials is facilitated by execution of computer-executable code stored on at least one memory medium, where the execution is by the at least one processor present in the at least one electronic device, sending, by the at least one electronic device, the at least one authentication credentials to the at least one Bluetooth module of the at least one Wi-Fi product, sending, by the at least one Bluetooth module, the at least one authentication credentials to at least one Wi-Fi module, wherein the at least one Wi-Fi module is configured in the at least one Wi-Fi product and communicatively linked with the at least one Bluetooth module, and registering, the at least one authentication credentials to the available Wi-Fi network for connecting the at least one Wi-Fi module to the available Wi-Fi network.

According to the same aspect, the registration of the at least one authentication credentials to the available Wi-Fi network connects the at least one Wi-Fi product to the available Wi-Fi network.

According to the same aspect, the sending, by the at least one electronic device, the at least one authentication credentials to the at least one Bluetooth module of the at least one Wi-Fi product is facilitated by an inbuilt Bluetooth module configured in the at least one electronic device. The inbuilt Bluetooth module configured in the at least one electronic device connects with the at least one Bluetooth module of the at least one Wi-Fi product and establishes the Bluetooth connection.

According to the same aspect, the sending by the at least one Bluetooth module, the at least one authentication credentials to the at least one Wi-Fi module is facilitated by a wired connection between the at least one Bluetooth module and the at least one Wi-Fi module.

According to the same aspect, the sending by the at least one Bluetooth module, the at least one authentication credentials to at least one Wi-Fi module is facilitated by a wireless connection between the at least one Bluetooth module and the at least one Wi-Fi module.

According to the same aspect, the available Wi-Fi network may be a conventional wireless internet connection, such as home Wi-Fi using Wi-Fi router with connection from the Internet service provider (ISP).

According to the same aspects of the present invention, the at least one authentication credentials comprises at least one selected from the group consisting essentially of a username, a username with associated password, a CAPTCHA, an email address.

According to the same aspects of the present invention, the at least electronic device comprises at least one selected from the group consisting essentially of a smartphone, a Personal Digital assistant (PDA), a mobile phone, a laptop, a tablet computer, a computer.

According to the same aspects of the present invention, the at least Wi-Fi product comprises at least one selected from the group consisting essentially of a computer and related accessories, one or more gaming media, a tablet, a camera, a TV, one or more smart home products.

According to the same aspects of the present invention, the one or more smart home products comprises at least one selected from the group consisting essentially of one or more energy monitors, one or more lighting gateways, one or more doorbells, one or more air conditioners, one or more thermostat

Additional aspects and objects of the present invention would appear and become clear as the detail description proceeds with the accompanying drawings.

### BRIEF DESCRIPTION OF THE DRAWINGS

For a more complete understanding of the present disclosure, reference is now made to the following descriptions taken in conjunction with the accompanying drawing, in which:

FIG. 1A illustrates a system for connecting a Wi-Fi product to a Wi-Fi network using a Bluetooth connection, according to an exemplary embodiment.

FIG. 1B shows a block diagram corresponding to the FIG. 1.

FIG. 2 illustrates a method for connecting a Wi-Fi product to a Wi-Fi network using a Bluetooth connection, according to an exemplary embodiment.

### DETAILED DESCRIPTION

Embodiments of the present disclosure will be described more fully hereinafter with reference to the accompanying drawings in which like numerals represent like elements throughout the figures, and in which example embodiments are shown. Embodiments of the claims may, however, be embodied in many different forms and should not be construed as limited to the embodiments set forth herein. The examples set forth herein are non-limiting examples and are merely examples among other possible examples.

Embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Again, for the ease of explanation and understanding, only a singular forms of the elements are used, for example, a Wi-Fi network, an electronic device, a Bluetooth module, a Wi-Fi product, a Wi-Fi module and so on. But it should be understood that the scope of claims is not limited to use of singular components and covers plural elements used or working together. Hence it should be understood that multiple Wi-Fi products may connect to the Wi-Fi network at the same instant.

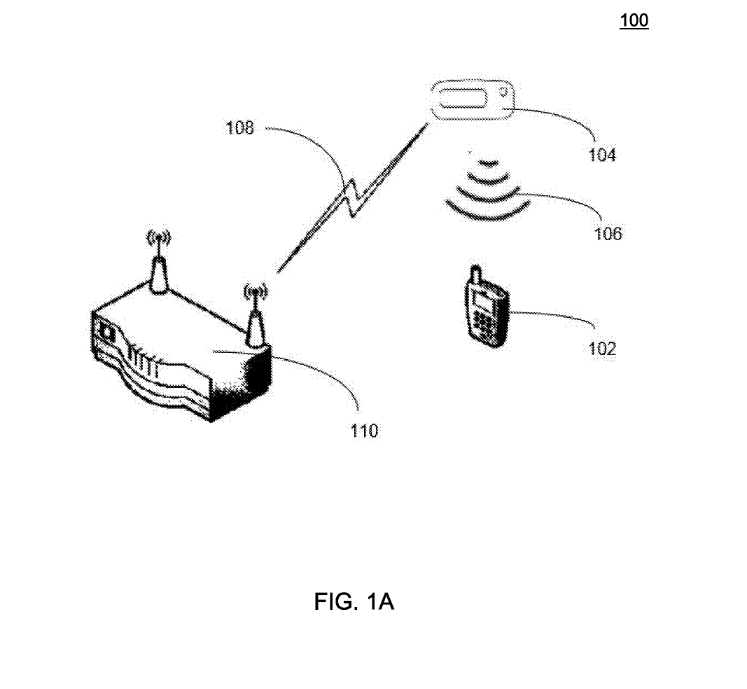

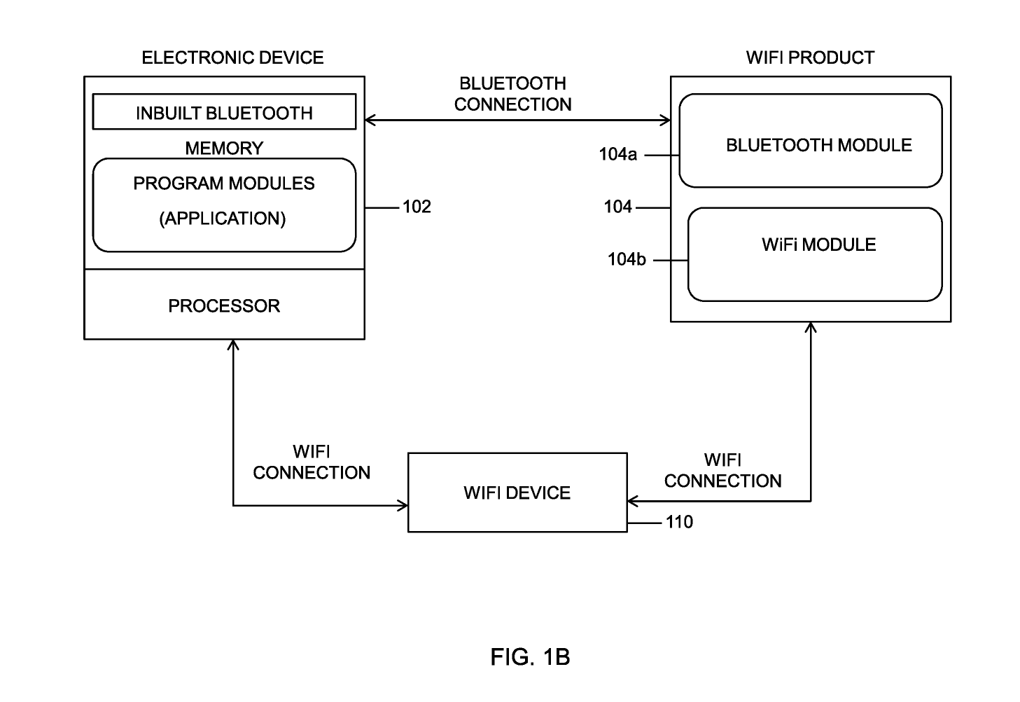

Referring to FIG. 1A and FIG. 1B illustrating a system for connecting a Wi-Fi product to an available Wi-Fi network, according to an embodiment. The system 100 includes an electronic device 102 and a Wi-Fi product 104. The Wi-Fi product 104 includes a Bluetooth module 104a and a Wi-Fi module 104b. The Wi-Fi product 104 preferably include but not limited to a computer and related accessories, a gaming media, a tablet, a camera, a TV, a smart home product. The smart home products are widely used at home and may preferably include but not limited to one or more energy monitors, one or more lighting gateways, one or more doorbells, one or more air conditioners, one or more thermostat

The system 100 further includes a Wi-Fi device 110, such as for example a Wi-Fi router. The electronic device 102 may be any device, such as a smart phone, a Personal Digital assistant (PDA), a mobile phone, a laptop, a tablet computer, a computer, preferably the smart phones which has a Bluetooth capability due to the presence of inbuilt Bluetooth module therein (as seen in FIG. 1B).

The electronic device 102 essentially includes a processor, and a memory medium as shown in FIG. 1B. According to the embodiment of the present invention, a set of computer-executable code may be configured onto the memory in the form of a software application which, when executed by processor enables a user of the electronic device 102 to input at least one authentication credentials related to the available Wi-Fi network created by the operating Wi-Fi device 110.

According to the embodiment, the Wi-Fi product 104 is connected to the electronic device 102 through a Bluetooth connection 106. The Bluetooth connection 106 may be Bluetooth Low Energy (BLE). After connecting the Wi-Fi product 104 to the electronic device 102, the authentication credentials associated with the Wi-Fi network is inputted on the application by the user using the electronic device 102 embodying the application.

In one embodiment, the authentication credentials may be a username, a username with a password, a CAPTCHA, or an email of the user to access the Wi-Fi network. The application residing on the electronic device 102 then sends the credentials to the Bluetooth module 104a configured in the Wi-Fi product 104. The Bluetooth module 104a may be understood as the module of the Wi-Fi product 104 which connects the Wi-Fi product 104 to the electronic device 102 through the Bluetooth connection 106. The Bluetooth module 104a sends the credentials to the Wi-Fi module 104b communicatively linked therewith for transferring the credentials to a Wi-Fi router/Wi-Fi device 110. The Wi-Fi router/Wi-Fi device 110 registers the credentials and establishes a Wi-Fi link 108 with the Wi-Fi product 104 (through the Wi-Fi module) when the credentials are registered to the Wi-Fi network. According to various embodiment, the Bluetooth module 104a and the Wi-Fi module 104b configured in the Wi-Fi product 104 may be wirelessly linked or may have a wired connection there between to communicate with each other.

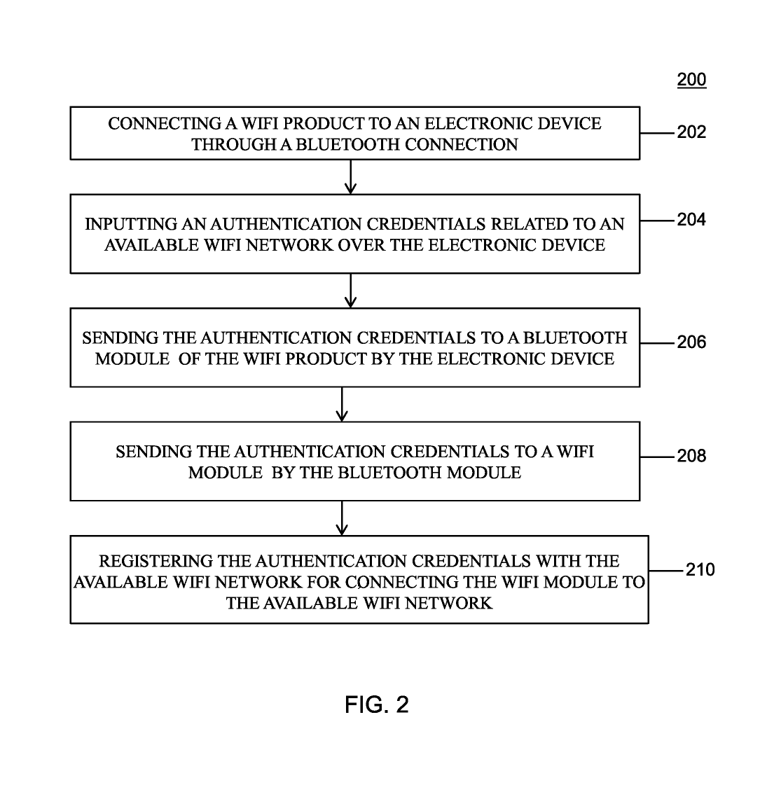

In another embodiment, referring to FIG. 2, a method 200 for connecting a Wi-Fi product to a Wi-Fi network using a Bluetooth connection is provided. Block 202 describes connecting the Wi-Fi product to an electronic device through a Bluetooth connection. The Wi-Fi product includes a Bluetooth module and a Wi-Fi module. This Bluetooth module helps the Wi-Fi product to connect with the inbuilt Bluetooth element of the electronic device.

At block 204, it is described that a user inputs authentication credentials on an application installed on the electronic device held by the user. The application is software program residing on the memory medium of the electronic device which when executed by the processor of the electronic devices helps the user input the authentication credentials. It should be understood by those skilled in the art that the application may be presented to the user for inputting the authentication credential in the form of user interfaces. The authentication credentials may preferably include but not limited to a username, a username with a password, an email address. The authentication credentials are associated with the Wi-Fi network of the Wi-Fi device.

At block 206, it is described that the authentication credentials are sent to the Bluetooth module of the Wi-Fi product by the application on the electronic device of the user. The transmission of the authentication credentials from the application on electronic device to the Bluetooth module of the Wi-Fi product is facilitated by the Bluetooth connection between the electronic device and the Bluetooth module of the Wi-Fi product.

At block 208, it is described that the authentication credentials is transmitted or sent to the Wi-Fi module by the Bluetooth module. The Wi-Fi module and the Bluetooth module configured in the Wi-Fi product may be wirelessly connected or may employ a wired connectivity for the communication.

At block 210, it is described that the Wi-Fi module of the Wi-Fi product registers the authentication credentials with the Wi-Fi network. The registration of the valid authentication credentials with the available Wi-Fi network connects the Wi-Fi product to the Wi-Fi network.

It will finally be understood that the disclosed embodiments are presently preferred examples of how to make and use the claimed disclosure, and are intended to be explanatory rather than limiting of the scope of the disclosure as defined by the claims below. Reasonable variations and modifications of the illustrated examples in the foregoing written specification and drawings are possible without departing from the scope of the disclosure as defined in the claim below. It should further be understood that to the extent the term “disclosure” or “present invention” used in the written specification, it is not to be construed as a limited term as to number of claimed or disclosed disclosures or the scope of any such disclosure, but as a term which has long been conveniently and widely used to describe new and useful improvements in technology. The scope of the present invention supported by the above disclosure should accordingly be construed within the scope of what it teaches and suggests to those skilled in the art, and within the scope of any claims that the above disclosure supports. The scope of the disclosure is accordingly defined by the following claims.

What is claimed is:

1. A method for connecting at least one Wi-Fi product to an available Wi-Fi network using a Bluetooth connection, comprising:
connecting, the at least one Wi-Fi product to at least one electronic device through the Bluetooth connection, wherein the connection with the at least one electronic device is established by the at least one Wi-Fi product using at least one Bluetooth module configured therein.
inputting, at least one authentication credentials related to the available Wi-Fi network over the at least one electronic device by a user, wherein the input of the at least one authentication credentials is facilitated by execution of computer-executable code stored on at least one memory medium, where the execution is by the at least one processor present in the at least one electronic device;
sending, by the at least one electronic device, the at least one authentication credentials to the at least one Bluetooth module of the at least one Wi-Fi product;
sending, by the at least one Bluetooth module, the at least one authentication credentials to at least one Wi-Fi module, wherein the at least one Wi-Fi module is configured in the at least one Wi-Fi product and communicatively linked with the at least one Bluetooth module; and
registering, the at least one authentication credentials with the available Wi-Fi network for connecting the at least one Wi-Fi module to the available Wi-Fi network.

2. The method of claim 1, wherein the at least one authentication credentials comprises at least one selected from the group consisting essentially of a username, a username with associated password, a CAPTCHA, and an email address.

3. The method of claim 1, wherein the registration of the at least one authentication credentials to the available Wi-Fi network connects the at least one Wi-Fi product to the available Wi-Fi network.

4. The method of claim 1, wherein the sending, by the at least one electronic device, the at least one authentication credentials to the at least one Bluetooth module of the at least one Wi-Fi product is facilitated by an inbuilt Bluetooth module configured in the at least one electronic device.

5. The method of claim 4, wherein the inbuilt Bluetooth module configured in the at least one electronic device connects with the at least one Bluetooth module of the at least one Wi-Fi product and establishes the Bluetooth connection.

6. The method of claim 1, wherein the sending by the at least one Bluetooth module, the at least one authentication credentials to the at least one Wi-Fi module is facilitated by a wired connection between the at least one Bluetooth module and the at least one Wi-Fi module.

7. The method of claim 1, wherein the sending by the at least one Bluetooth module, the at least one authentication credentials to at least one Wi-Fi module is facilitated by a wireless connection between the at least one Bluetooth module and the at least one Wi-Fi module.

8. The method of claim 1, wherein the available Wi-Fi network includes a conventional wireless internet connection.

9. The method of claim 1, wherein the at least electronic device comprises at least one selected from the group consisting essentially of a smart phone, a Personal Digital assistant (PDA), a mobile phone, a laptop, a tablet computer, and a computer.

10. The method of claim 1, wherein the at least Wi-Fi product comprises at least one selected from the group consisting essentially of a computer and related accessories, one or more gaming media, a tablet, a camera, a TV, and one or more smart home products.

11. The method of claim 10, wherein the one or more smart home products comprises at least one selected from the group consisting essentially of one or more energy monitors, one or more lighting gateways, one or more doorbells, one or more air conditioners, one or more thermostat

12. A system for connecting at least one Wi-Fi product to an available Wi-Fi network using a Bluetooth connection, comprising:
at least electronic device comprising at least one processor, at least one memory medium, the at least one memory medium having stored thereon computer-executable code which, when executed by the at least one processor enables a user to input at least one authentication credentials related to the available Wi-Fi network over the at least one electronic device;
at least one Bluetooth module configured in the at least one Wi-Fi product for establishing the Bluetooth connection with the at least electronic device, wherein the Bluetooth connection enables the at least one Bluetooth module to receive the at least one authentication credentials inputted by the user on the at least one electronic device; and
at least one Wi-Fi module configured in the at least one Wi-Fi product, wherein the at least one Wi-Fi module is communicatively linked with the at least one Bluetooth module to receive the at least one authentication credentials there from for registering and connecting the at least one Wi-Fi product with the available Wi-Fi network.

13. The system of claim 12, wherein the at least one authentication credentials comprises at least one selected from the group consisting essentially of a username, a username with associated password, a CAPTCHA, and an email address.

14. The system of claim 12, wherein the at least electronic device comprises at least one selected from the group consisting essentially of a Smartphone, a Personal Digital assistant (PDA), a mobile phone, a laptop, a tablet computer, and a computer.

15. The system of claim 12, wherein the at least Wi-Fi product comprises at least one selected from the group consisting essentially of a computer and related accessories, one or more gaming media, a tablet, a camera, a TV, and one or more smart home products.

16. The system of claim 15, wherein the one or more smart home products comprises at least one selected from the group consisting essentially of one or more energy monitors, one or more lighting gateways, one or more doorbells, one or more air conditioners, one or more thermostat
